(19) United States
(12) Patent Application Publication
(10) Pub. No.: US 2022/0234701 A1
(43) Pub. Date: Jul. 28, 2022

(54) RESCUE SYSTEM

(71) Applicant: HONDA MOTOR CO., LTD., Tokyo (JP)

(72) Inventor: Satoshi SUDA, Saitama (JP)

(21) Appl. No.: 17/577,709

(22) Filed: Jan. 18, 2022

(30) Foreign Application Priority Data
Jan. 25, 2021 (JP) 2021-009565

(51) Int. Cl. B63C 9/00; B63B 79/10; B63B 79/40; G05D 1/02

(52) U.S. Cl. CPC B63C 9/0005; B63B 79/10; B63B 2201/00; G05D 1/0206; B63B 79/40

(57) ABSTRACT

A rescue system for a watercraft includes: a control device provided in the watercraft; a portable device held by a person on board the watercraft and communicating with the control device; and a position detection device that detects a position of the watercraft. The control device detects a fall of the person from the watercraft based on a signal from the portable device, stores the position of the watercraft indicated by a signal from the position detection device when the fall of the person from the watercraft is detected as an overboard event detection position, and controls at least one of a propulsion device and a steering device of the watercraft based on the overboard event detection position and the current position of the watercraft such that a current position of the watercraft approaches the overboard event detection position.

### TECHNICAL FIELD

The present invention relates to a rescue system for a watercraft.

### BACKGROUND ART

JP6605363B2 discloses an emergency stop apparatus of a watercraft such as a small boat. The emergency stop apparatus includes a transmitter held by a person of the watercraft to transmit a radio signal, a receiver installed on the boat to receive the radio signal transmitted by the transmitter, and a control device that, based on the received radio signal, stops the engine of the watercraft in emergency. The control device stops the engine when it is determined that the person having the transmitter has fallen overboard from the watercraft based on the strength of the received radio signal. According to the emergency stop apparatus disclosed by JP6605363B2, when a person (a crew member or a passenger of the watercraft) falls overboard from the watercraft, it is possible to prevent the watercraft from moving away from the person in the water.

However, even though the engine is stopped in emergency, the watercraft keeps moving forward due to the inertia, and therefore, the distance between the watercraft and the person who has fallen overboard from the watercraft (hereinafter referred to as the “overboard person”) may widen. To quickly rescue the overboard person, it is preferred to keep the watercraft positioned near the overboard person.

### SUMMARY OF THE INVENTION

In view of the foregoing background, a primary object of the present invention is to provide a rescue system for a watercraft which enables quick rescue of an overboard person.

To achieve the above object, one aspect of the present invention provides a rescue system (1) for a watercraft (2), comprising: a control device (3) provided in the watercraft; a portable device (4) held by a person on board the watercraft and communicating with the control device; and a position detection device (17) that detects a position of the watercraft, wherein the control device detects a fall of the person from the watercraft based on a signal from the portable device, stores the position of the watercraft indicated by a signal from the position detection device when the fall of the person from the watercraft is detected as an overboard event detection position, and controls at least one of a propulsion device (7) and a steering device (8) of the watercraft based on the overboard event detection position and a current position of the watercraft such that the current position of the watercraft approaches the overboard event detection position.

According to this aspect, since the control device of the rescue system detects an overboard person based on the signal from the portable device and makes the watercraft approach the overboard person, quick rescue of the overboard person can be achieved.

In the above aspect, preferably, when the fall of the person from the watercraft is detected, the control device performs a stop control to stop the propulsion device or to make a speed of the propulsion device extremely low and thereafter controls the propulsion device and the steering device to make the watercraft automatically navigate toward the overboard event detection position.

According to this aspect, it is possible to make the watercraft approach the overboard person.

In the above aspect, preferably, the control device stops the propulsion device when a distance between the overboard event detection position and the current position of the watercraft is less than or equal to a prescribed determination value.

According to this aspect, it is possible to prevent the overboard person from being caught in the propulsion device.

In the above aspect, preferably, the rescue system further comprises a rescue equipment ejection device that ejects rescue equipment from the watercraft to an outside, wherein the control device causes the rescue equipment ejection device to eject the rescue equipment when a distance between the overboard event detection position and the current position of the watercraft is less than or equal to a prescribed determination value.

According to this aspect, it is possible to quickly provide the overboard person with the rescue equipment.

In the above aspect, preferably, the control device transmits a rescue request signal when a return switch (13) is not operated by a time when a prescribed time has elapsed from when the fall of the person from the watercraft was detected.

According to this aspect, when it is taking time to rescue the overboard person, the control device can automatically transmit the rescue request signal.

In the above aspect, preferably, the control device acquires a distance between the control device and the portable device based on the signal from the portable device and determines that the person has fallen from the watercraft when the distance between the control device and the portable device is greater than or equal to a prescribed determination value.

According to this aspect, the control device can detect the fall of the person from the watercraft.

In the above aspect, preferably, the control device determines that the person has fallen from the watercraft when the control device cannot receive the signal from the portable device.

According to this aspect, the control device can detect the fall of the person from the watercraft.

In the above aspect, preferably, the portable device has a water detection sensor (52) that detects contact with water, and transmits or stops a water detection signal to the control device according to a detection state of water, and the control device determines that the person has fallen from the watercraft based on the water detection signal.

According to this aspect, the control device can detect the fall of the person from the watercraft.

In the above aspect, preferably, the portable device acquires the position of the portable device based on a GNSS signal and transmits a rescue signal containing the position of the portable device.

According to this aspect, even when the watercraft which the person was on board does not perform rescue work for some reason, the portable device can request rescue to other watercraft or the control station.

According to the foregoing configuration, it is possible to provide a rescue system for a watercraft which enables quick rescue of an overboard person.

### BRIEF DESCRIPTION OF THE DRAWINGS

FIG. 1 is an explanatory diagram of a rescue system according to an embodiment of the present invention;

FIG. 2 is a block diagram of the rescue system;

FIG. 3 is a block diagram of a portable device;

FIG. 4 is a flowchart showing a procedure of an overboard event detection process; and

FIG. 5 is a flowchart showing a procedure of an automatic navigation process.

### DETAILED DESCRIPTION OF THE INVENTION

In the following, a rescue system for a watercraft according to an embodiment of the present invention will be described with reference to the drawings.

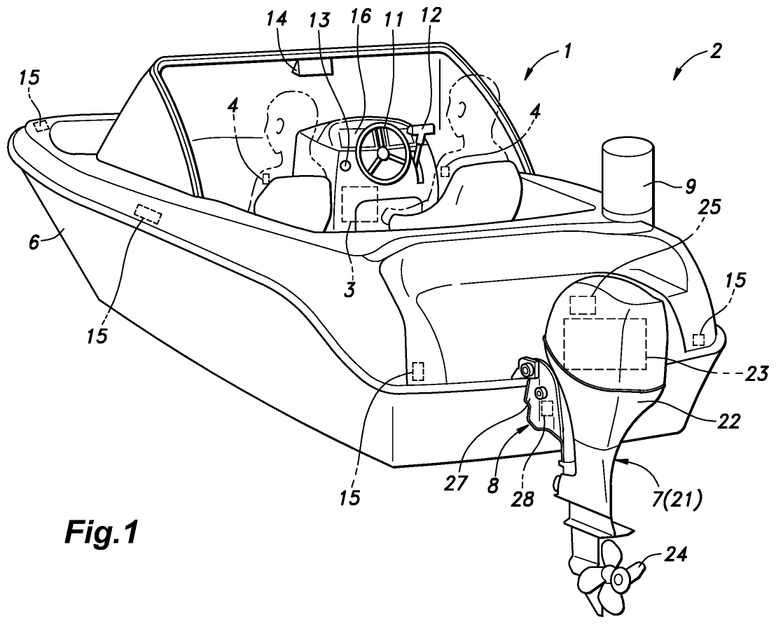

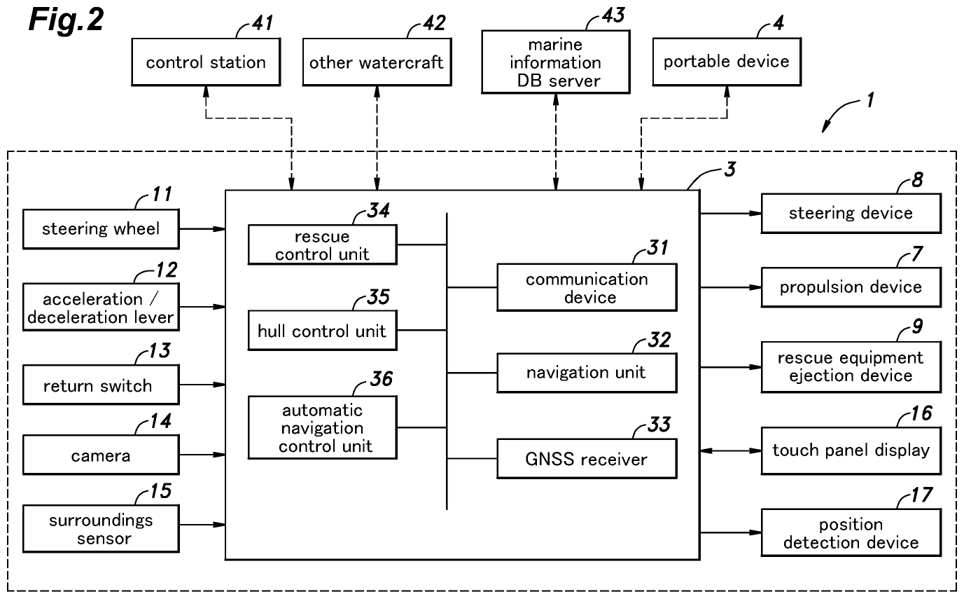

As shown in FIGS. 1 and 2, a rescue system 1 includes a control device 3 provided in a watercraft 2 and a portable device 4 which is held by a person on board the watercraft 2 and communicates with the control device 3. The rescue system 1 preferably includes multiple portable devices 4 in accordance with the number of persons on board. The control device 3 is constituted of one or more electronic control units (ECUs) each including a CPU, a ROM, a RAM, etc. The control device 3 is provided in the hull 6 of the watercraft 2.

The hull 6 is provided with a propulsion device 7, a steering device 8, a rescue equipment ejection device 9, a steering wheel 11, an acceleration/deceleration lever 12, a return switch 13, a camera 14, a surroundings sensor 15, a touch panel display 16, and a position detection device 17. The propulsion device 7, the steering device 8, the rescue equipment ejection device 9, the steering wheel 11, the acceleration/deceleration lever 12, the return switch 13, the camera 14, the surroundings sensor 15, the touch panel display 16, and the position detection device 17 are connected with the control device 3.

In the present embodiment, the propulsion device 7 is an outboard motor 21 mounted on the stern of the hull 6. The outboard motor 21 includes a vertically extending case 22, a drive source 23 consisting of an engine or an electric motor and accommodated in the case 22, a propeller 24 provided on a lower portion of the case 22 so as to be rotated by a driving force of the drive source 23, and an outboard motor ECU 25 that controls the drive source 23. the outboard motor ECU 25 is constituted of an electronic control unit (ECU) including a CPU, a ROM, a RAM, etc. In the case where the drive source 23 is an electric motor, the outboard motor ECU 25 preferably includes an inverter circuit. The outboard motor ECU 25 receives a control signal from the control device 3 and accordingly controls the drive source 23.

The steering device 8 includes a stern bracket 27 that supports the outboard motor 21 on the hull 6 so as to be pivotable about a vertical axis and a steering actuator 28 for pivoting the outboard motor 21 about the vertical axis relative to the hull 6.

The steering wheel 11 receives a steering operation of a person on board and outputs a signal according to the steering operation to the control device 3. The acceleration/deceleration lever 12 receives an acceleration/deceleration operation of the person on board and outputs a signal according to the acceleration/deceleration operation to the control device 3.

The rescue equipment ejection device 9 is a device that ejects the rescue equipment from the watercraft 2 to the outside. Preferably, the rescue equipment is a lifebuoy connected to the hull 6 by a rope, for example. The rescue equipment ejection device 9 is configured to fling the rescue equipment a prescribed distance by using the driving force of the electric motor or the explosive power of gunpowder, for example. Preferably, the rescue equipment ejection device 9 can change the ejection direction of the rescue equipment relative to the hull 6. For example, the rescue equipment ejection device 9 is provided to be pivotable about a vertical axis relative to the hull 6 and is caused to pivot relative to the hull 6 by the driving force of the electric motor. Also preferably, the rescue equipment ejection device 9 can change the flying distance of the rescue equipment by adjusting the output.

The camera 14 captures images of the surroundings of the hull 6. The camera 14 may be a digital camera using a solid imaging element such as a CCD or a CMOS, for example. At least one camera 14 is provided at an appropriate position on the hull 6. The camera 14 includes at least a front camera configured to capture images in front of the hull 6, and preferably includes a rear camera configured to capture images behind the hull 6 and a pair of side cameras configured to capture images on the left and right sides of the hull 6. The camera 14 preferably is a stereo camera, for example.

The surroundings sensor 15 may be a sonar, radar, lidar, or the like. The sonar, radar, lidar, or the like emits sound waves or electromagnetic waves to the surroundings from the hull 6 and captures the waves reflected by an object around the hull 6 thereby to detect the position (distance and direction) of the object. At least one surroundings sensor 15 is provided at an appropriate position on the hull 6. Preferably, multiple surroundings sensors 15 are provided on the front, rear, left, and right sides of the hull 6.

The return switch 13 is provided on the hull 6 to receive an operation of a person on board. Based on the signal from the return switch 13, the control device 3 ends the later-described rescue control. The touch panel display 16 outputs images and receives a touch operation of the person on board.

The position detection device 17 includes a GNSS (Global Navigation Satellite System) receiver and acquires the position of the watercraft 2 based on a received GNSS signal.

The control device 3 includes a communication device 31, a navigation unit 32, a rescue control unit 34, a hull control unit 35, and an automatic navigation control unit 36. The communication device 31, the navigation unit 32, the rescue control unit 34, the hull control unit 35, and the automatic navigation control unit 36 may be realized by a single electronic control unit or may be realized by multiple electronic control units that are connected to each other.

The communication device 31 includes a receiver and a transmitter and wirelessly communicates with the control station 41, multiple other watercraft 42 in the surroundings, a marine information database (DB) server 43, and multiple portable devices 4 held by respective persons on board.

The navigation unit 32 acquires the position of the watercraft 2 from the position detection device 17. In addition, the navigation unit 32 communicates with the marine information DB server 43 via the communication device 31 to acquire marine information. The navigation unit 32 includes marine map data and creates a route to the destination based on the position of the own watercraft 2 and the destination. The destination is preferably input by a person on board via the touch panel display 16. The navigation unit 32 creates a navigation image including the position of the watercraft 2, a marine map around the watercraft 2, and the route to the destination and displays the navigation image on the touch panel display 16.

The hull control unit 35 controls the steering actuator 28 of the steering device 8 in accordance with the signal from the steering wheel 11. Thereby, the hull control unit 35 changes the angle of the outboard motor 21 relative to the hull 6, namely, the steering angle. Also, the hull control unit 35 generates an acceleration/deceleration request for the outboard motor 21 in accordance with the signal from the acceleration/deceleration lever 12, and outputs the acceleration/deceleration request to the outboard motor ECU 25. The outboard motor ECU 25 controls the drive source 23 based on the acceleration/deceleration request. Thereby, the hull control unit 35 changes the acceleration of the hull 6. The outboard motor ECU 25 may be configured integrally with the control device 3 as a part of the hull control unit 35. Also, the hull control unit 35 controls the steering device 8 and the outboard motor 21 in accordance with the signal from the automatic navigation control unit 36.

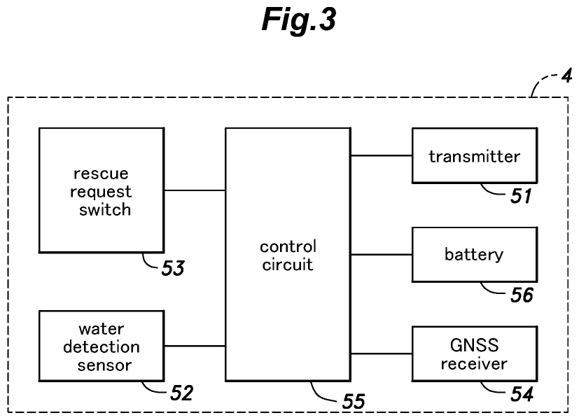

The rescue control unit 34 detects a fall of a person from the watercraft 2 (hereinafter may be referred to as an “overboard event”) based on the signal from the portable device 4 carried by each person on board. As shown in FIG. 3, the portable device 4 includes a transmitter 51 that transmits a radio signal, a water detection sensor 52 that detects contact with water, a rescue request switch 53, a GNSS receiver 54, a control circuit 55, and a battery 56. The water detection sensor 52 is preferably constituted of an electric circuit that becomes short circuited so that the voltage is lowered when contacting with water, for example. The control circuit 55 normally makes the transmitter 51 transmits a first radio signal of a prescribed strength. Also, the control circuit 55 preferably makes the transmitter 51 transmit or stop a second radio signal (water detection signal) according to a detection state of water indicated by a signal from the water detection sensor 52. For example the control circuit 55 transmits the second radio signal when the water detection sensor 52 detects water and stops the transmission of the second radio signal when the water detection sensor 52 does not detect water. Alternatively, the control circuit 55 may transmit the second radio signal when the water detection sensor 52 does not detect water and stops the transmission of the second radio signal when the water detection sensor 52 detects water. In the present embodiment, the control circuit 55 transmits the second radio signal when the water detection sensor 52 detects water. The control circuit 55 continues transmission of the first radio signal regardless of presence or absence of transmission of the second radio signal. Also, based on the signal from the rescue request switch 53, the control circuit 55 makes the transmitter 51 transmit a rescue radio signal when the rescue request switch 53 is pressed. The portable device 4 is preferably formed in a card shape or a tag shape. Also, the portable device 4 may be incorporated in the equipment worn by the person, such as a wrist band or a belt.

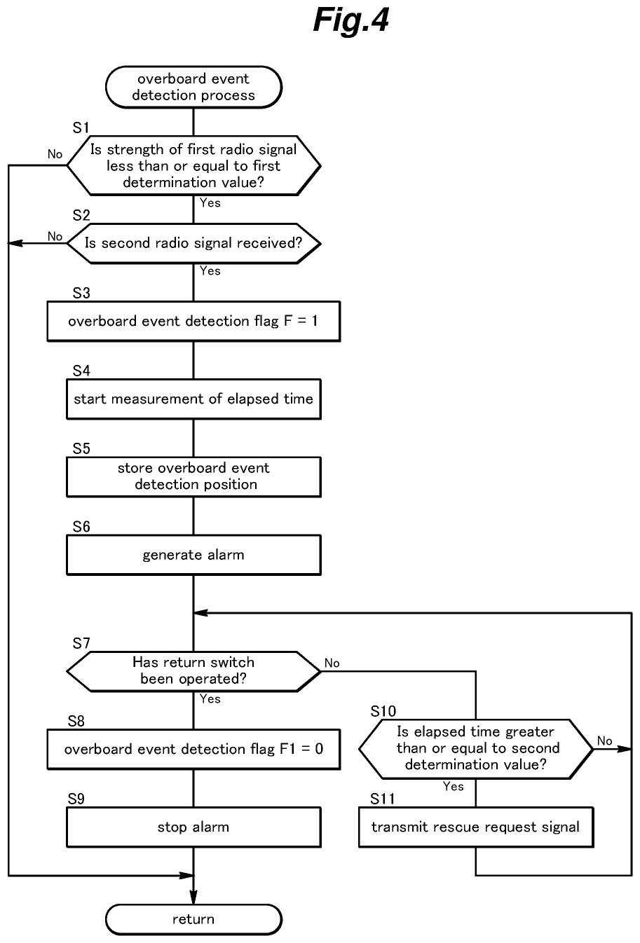

In accordance with an overboard event detection process shown in FIG. 4, the rescue control unit 34 detects an overboard event based on the signal from the portable device 4, and when an overboard event is detected, stores the position of the watercraft 2 indicated by the signal from the position detection device 17 as an overboard event detection position.

The rescue control unit 34 executes the overboard event detection process shown in FIG. 4 at a prescribed time interval. First, the rescue control unit 34 determines whether the strength of the first radio signal received by the communication device 31 from the portable device 4 is less than or equal to a prescribed first determination value (S1). When the strength of the first radio signal is less than or equal to the prescribed determination value, it can be inferred that the person holding the portable device 4 has fallen overboard and is apart from the control device 3 by a distance greater than or equal to a prescribed distance.

When the strength of the first radio signal is less than or equal to the determination value (the determination result in S1 is Yes), the rescue control unit 34 determines whether the second radio signal is received (S2). When the water detection sensor 52 detects water, the portable device 4 transmits the second radio signal. Therefore, when the rescue control unit 34 receives the second radio signal, it can be inferred that the person holding the portable device 4 is in the water.

When the second radio signal is received (the determination result in S2 is Yes), the rescue control unit 34 determines that the person has fallen into the water and sets an overboard event detection flag F1 to 1 (S3). Note that the initial value of the overboard event detection flag F1 is set to 0. Subsequently, the rescue control unit 34 starts measurement of an elapsed time from when the overboard event detection flag F1 is set to 1 (S4).

Subsequently, based on the signal from the position detection device 17, the rescue control unit 34 stores the position of the watercraft 2 as an overboard event detection position (S5). Then, the rescue control unit 34 generates an alarm to notify that a person has fallen into the water (S6). The rescue control unit 34 preferably displays the alarm on the touch panel display 16 and/or outputs from a speaker, for example.

Next, the rescue control unit 34 determines whether the return switch 13 has been pressed (S7). The return switch 13 is configured to be operated by a person on board the watercraft 2. A person on board operates the return switch 13 when the rescue control by the control device 3 should be stopped. When the return switch 13 has been operated (the determination result in S7 is Yes), the rescue control unit 34 sets the overboard event detection flag F1 back to 0 (S8) and stops the alarm (S9). Thereafter, the rescue control unit 34 repeats the process from S1.

When the return switch 13 has not been pressed (the determination result in S7 is No), the rescue control unit 34 determines whether the elapsed time is greater than or equal to a prescribed second determination value (S10). As the case where the elapsed time becomes greater than or equal to the second determination value, it is assumed that the overboard event of a person is not noticed by the other persons on the hull 6 or that the persons on the hull 6 noticed the overboard event of the person but the rescue work is taking time, for example. When the elapsed time is greater than or equal to the second determination value (the determination result in S10 is Yes), the rescue control unit 34 transmits a rescue request signal via the communication device 31 (S11). The rescue request signal preferably contains information related to the overboard event detection position. The rescue request signal is received by other watercraft 2 traveling around the own watercraft 2 and the control station 41. The other watercraft 2 and the control station 41 which received the rescue request signal start rescue actions. When the elapsed time is less than the second determination value (the determination result in S10 is No), the rescue control unit 34 executes the process in step S7 again.

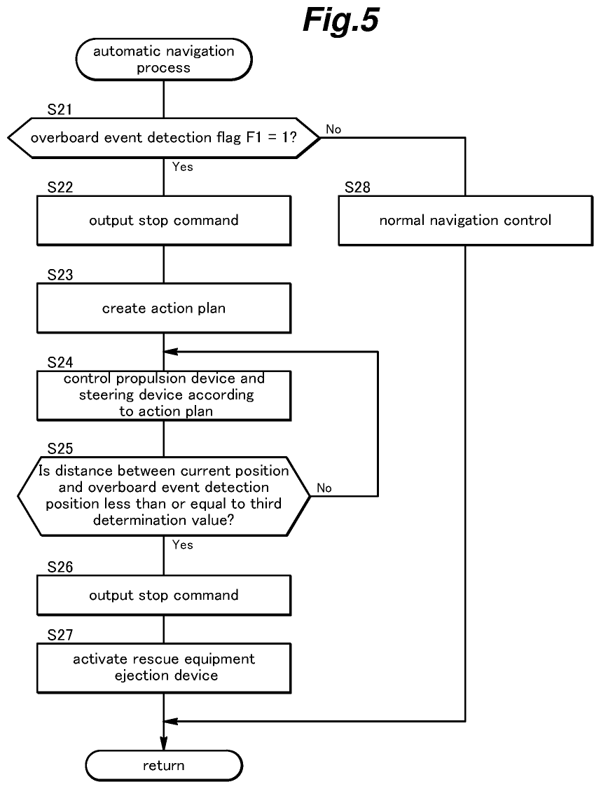

When the rescue control unit 34 detects an overboard event of a person, the automatic navigation control unit 36 controls at least one of the propulsion device 7 and the steering device 8 of the watercraft 2 based on the overboard event detection position and the current position of the watercraft 2 such that the current position of the watercraft 2 approaches the overboard event detection position. Preferably, the automatic navigation control unit 36 controls at least one of the propulsion device 7 and the steering device 8 in accordance with an automatic navigation process shown in FIG. 5.

In the automatic navigation process, the automatic navigation control unit 36 first determines whether the overboard event detection flag F1 is 1 (S21). As described above, the overboard event detection flag F1 is set by the rescue control unit 34 such that, when the rescue control unit 34 detects an overboard event of a person, the overboard event detection flag F1 is set to 1.

When the overboard event detection flag F1 is 1 (the determination result in S21 is Yes), the automatic navigation control unit 36 outputs a stop command to the hull control unit 35 to stop the propulsion device 7 (S22). Upon receipt of the stop command, the hull control unit 35 stops the propulsion device 7. Thereby, the watercraft 2 stops. In another embodiment, the automatic navigation control unit 36 may conduct control to drive the propulsion device 7 at an extremely low speed such that the influence of ocean current is cancelled and the position of the watercraft 2 is maintained.

Next, the automatic navigation control unit 36 creates an action plan for making the watercraft 2 automatically navigate from the current position of the watercraft 2 to the overboard event detection position (S23). The action plan includes a time schedule of increase and decrease of the output of the propulsion device 7 and a time schedule of increase and decrease of the output of the steering actuator 28 of the steering device 8.

Next, the automatic navigation control unit 36 controls the propulsion device 7 and the steering device 8 according to the action plan (S24). The automatic navigation control unit 36 sets the required control amount of the propulsion device 7 and the required control amount of the steering device 8 at each point in time based on the action plan, and outputs the required control amount of the propulsion device 7 and the required control amount of the steering device 8 to the hull control unit 35. The hull control unit 35 controls the propulsion device 7 and the steering device 8 according to the required control amount of the propulsion device 7 and the required control amount of the steering device 8. Thereby, the watercraft 2 travels toward the overboard event detection position. The process of step S24 may be executed after a prescribed standby time has elapsed from when the process of step S22 is executed.

Next, the automatic navigation control unit 36 determines whether the distance between the current position of the watercraft 2 acquired by the position detection device 17 and the overboard event detection position has become less than or equal to a prescribed third determination value (S25). When the distance between the current position of the watercraft 2 and the overboard event detection position is greater than the third determination value (the determination result in S25 is No), the automatic navigation control unit 36 executes the process of step S24 again.

When the distance between the current position of the watercraft 2 and the overboard event detection position is less than or equal to the third determination value (the determination result in S25 is Yes), the automatic navigation control unit 36 outputs a stop command the hull control unit 35 to stop the propulsion device 7 (S26). Upon receipt of the stop command, the hull control unit 35 stops the propulsion device 7. Thereby, the watercraft 2 stops.

Subsequently, the automatic navigation control unit 36 outputs an activation command to the rescue equipment ejection device 9 to activate the rescue equipment ejection device 9 (S27). Upon receipt of the activation command, the rescue equipment ejection device 9 ejects the rescue equipment to the outside of the hull 6. Preferably, the activation command contains a target ejection angle of the rescue equipment relative to the hull 6 and the rescue equipment ejection device 9 sets the ejection angle of the rescue equipment relative to the hull 6 based on the target ejection angle. Preferably, the automatic navigation control unit 36 acquires the position of the person who has fallen overboard from the hull 6 (hereinafter may be referred to as the “overboard person”) relative to the hull 6 based on at least one of the image data acquired by the camera 14 and the signal from the surroundings sensor 15 and decides the ejection angle based on the position of the overboard person.

When it is determined in step S21 that the overboard event detection flag F1 is 0 (the determination result in S21 is No), the automatic navigation control unit 36 executes normal navigation control (S28). In the normal navigation control, preferably, the automatic navigation control unit 36 creates an action plan for making the watercraft 2 automatically navigate from the current position of the watercraft 2 to the destination, sets the required control amount of the propulsion device 7 and the required control amount of the steering device 8 at each point in time based on the action plan, and outputs the required control amount of the propulsion device 7 and the required control amount of the steering device 8 to the hull control unit 35. The destination is preferably input by a person on board via the touch panel display 16.

Preferably, the automatic navigation control unit 36 cancels the automatic navigation process of FIG. 5 when the signal from the return switch 13 indicates that the return switch 13 is operated.

The control device 3 of the rescue system 1 according to the embodiment detects an overboard person based on the signal from the portable device 4 and makes the watercraft 2 approach the overboard person. Therefore, quick rescue of the overboard person can be achieved. In addition, since the control device 3 determines an overboard event of a person based on the distance between the watercraft 2 and the overboard person and the presence or absence of detection of water by the water detection sensor 52, erroneous detection of an overboard event of a person can be avoided.

The control device 3 stores the position indicated by the signal from the position detection device 17 when an overboard event of a person is detected as the overboard event detection position, and therefore, the position of the overboard person can be identified. Also, the control device 3 makes the watercraft 2 automatically navigate toward the overboard event detection position even though a person on the watercraft 2 does not manually operate. Therefore, even in such cases as when the fall of a person into the water is not noticed by the other persons on the watercraft 2 or when the persons on board cannot perform rescue actions for some reason, quick rescue of the overboard person can be performed.

When an overboard event of a person is detected, the control device 3 executes the stop control to stop the propulsion device 7 (S22), and this prevents the watercraft 2 from moving away from the overboard person. Also, after the stop control, the control device 3 makes the watercraft 2 automatically navigate toward the overboard event detection position (S23, S24), thereby to make the watercraft 2 approach the overboard person. In addition, since the control device 3 stops the propulsion device 7 when the distance between the overboard event detection position and the current position of the watercraft 2 is less than or equal to the third determination value (S25, S26), it is possible to prevent the overboard person from being caught in the propulsion device 7. Further, since the control device 3 makes the rescue equipment ejection device 9 eject the rescue equipment when the distance between the overboard event detection position and the current position of the watercraft 2 is less than or equal to the third determination value, it is possible to quickly provide the overboard person with the rescue equipment.

The control device 3 transmits the rescue request signal when the return switch 13 is not operated by the time when the prescribed time has elapsed from when an overboard event of a person was detected (S7, S10, S11). Thereby, when it is taking time to rescue the overboard person, the control device 3 can automatically transmit the rescue request signal.

The portable device 4 acquires the position of the portable device 4 based on the GNSS signal and transmits the rescue signal containing the position of the portable device 4. Thereby, even when the watercraft 2 which the person was on board does not perform rescue work for some reason, the portable device 4 can request rescue to other watercraft 2 or the control station 41.

Concrete embodiments of the present invention have been described in the foregoing, but the present invention is not limited to the above embodiments and may be modified or altered in various ways. For example, in another embodiment, the GNSS receiver 54 and the rescue request switch 53 of the portable device 4 may be omitted. In this case, the configuration of the portable device 4 can be simplified and the size of the portable device 4 can be reduced.

In another embodiment, the rescue equipment ejection device 9 may be omitted from the rescue system 1. In this case, the process of step S27 in the automatic navigation process preferably is omitted.

In another embodiment, the processes of steps S23, S24, S25, and S26 in the automatic navigation process may be omitted. In this case, when an overboard event of a person is detected, the rescue system 1 stops the propulsion device 7 (S22) and does not cause the watercraft 2 to move toward the overboard event detection position. According to this aspect, the configuration of the control device 3 can be simplified.

In another embodiment, the processes of step S4, S10, and S11 in the overboard event detection process may be omitted.

In another embodiment, the rescue control unit 34 may determine that a person has fallen into the water when at least one of the two conditions that the strength of the first radio signal is less than or equal to the first determination value (S1) and that the second radio signal is received (S2) is satisfied. Also, the rescue control unit 34 may determine that a person has fallen into the water when the first radio signal transmitted from the portable device 4 cannot be received.

In another embodiment, the determination condition of step S7 may be replaced by a condition that the strength of the first radio signal received by the communication device 31 has become greater than or equal to a prescribed determination value. Also, the determination condition of step S7 may be replaced with a condition that the communication device 31 no longer receives the second radio signal.

Instead of the outboard motor 21, the propulsion device 7 may be a propeller or a water jet provided at the bottom of the watercraft. Also, the steering device 8 may be configured by a rudder pivotably provided on the hull 6 and an actuator for pivoting the rudder. Also, the size of the watercraft 2 is not limited, and the watercraft 2 may be any watercraft of various sizes, such as a fishing boat, a tanker, and so on.

1. A rescue system for a watercraft, comprising:
a control device provided in the watercraft;
a portable device held by a person on board the watercraft and communicating with the control device; and
a position detection device that detects a position of the watercraft,
wherein the control device detects a fall of the person from the watercraft based on a signal from the portable device, stores the position of the watercraft indicated by a signal from the position detection device when the fall of the person from the watercraft is detected as an overboard event detection position, and controls at least one of a propulsion device and a steering device of the watercraft based on the overboard event detection position and a current position of the watercraft such that the current position of the watercraft approaches the overboard event detection position.

2. The rescue system according to claim 1, wherein when the fall of the person from the watercraft is detected, the control device performs a stop control to stop the propulsion device or to make a speed of the propulsion device extremely low and thereafter controls the propulsion device and the steering device to make the watercraft automatically navigate toward the overboard event detection position.

3. The rescue system according to claim 1, wherein the control device stops the propulsion device when a distance between the overboard event detection position and the current position of the watercraft is less than or equal to a prescribed determination value.

4. The rescue system according to claim 1, further comprising a rescue equipment ejection device that ejects rescue equipment from the watercraft to an outside,
wherein the control device causes the rescue equipment ejection device to eject the rescue equipment when a distance between the overboard event detection position and the current position of the watercraft is less than or equal to a prescribed determination value.

5. The rescue system according to claim 1, wherein the control device transmits a rescue request signal when a return switch is not operated by a time when a prescribed time has elapsed from when the fall of the person from the watercraft was detected.

6. The rescue system according to claim 1, wherein the control device acquires a distance between the control device and the portable device based on the signal from the portable device and determines that the person has fallen from the watercraft when the distance between the control device and the portable device is greater than or equal to a prescribed determination value.

7. The rescue system according to claim 1, wherein the control device determines that the person has fallen from the watercraft when the control device cannot receive the signal from the portable device.

8. The rescue system according to claim 1, wherein the portable device has a water detection sensor that detects contact with water, and transmits or stops a water detection signal to the control device according to a detection state of water, and
the control device determines that the person has fallen from the watercraft based on the water detection signal.

9. The rescue system according to claim 1, wherein the portable device acquires the position of the portable device based on a GNSS signal and transmits a rescue signal containing the position of the portable device.
